(19) United States
(12) Patent Application Publication
(10) Pub. No.: US 2025/0095341 A1
(43) Pub. Date: Mar. 20, 2025

(54) METHOD AND SYSTEM FOR ACQUIRING VISUAL EXPLANATION INFORMATION INDEPENDENT OF PURPOSE, TYPE, AND STRUCTURE OF VISUAL INTELLIGENCE MODEL

(71) Applicant: Korea Electronics Technology Institute, Seongnam-si (KR)

(72) Inventors: Choong Sang CHO, Seongnam-si (KR); Young Han LEE, Seongnam-si (KR); Gui Sik KIM, Seongnam-si (KR); Tae Woo KIM, Seongnam-si (KR)

(73) Assignee: Korea Electronics Technology Institute, Seongnam-si (KR)

(21) Appl. No.: 18/741,942

(22) Filed: Jun. 13, 2024

(30) Foreign Application Priority Data
Sep. 15, 2023 (KR) 10-2023-0122954

(51) Int. Cl. G06V 10/776; G06V 10/22; G06V 10/74; G06V 10/764; G06V 10/77

(52) U.S. Cl. CPC G06V 10/776; G06V 10/235; G06V 10/761; G06V 10/764; G06V 10/7715

(57) ABSTRACT

There are provided a method and a system for acquiring visual explanation information independent of the purpose, type, and structure of a visual intelligence model. The visual explanation information acquisition system of the visual intelligence model according to an embodiment may input N transformed images which are generated by diversifying an input image to a deep learning-based visual intelligence model and may acquire outputted results, may generate attributes of the visual intelligence model from the acquired results, may derive, from losses of the visual intelligence model which are calculated from the generated attributes, basic data for generating a visual explanation map for visually explaining a result derivation rationale of the visual intelligence model, and may generate a visual explanation map from the derived basic data. Accordingly, visual explanation information may be acquired from various visual intelligence models through one system independently of the purpose, type, and structure of the visual intelligence model.

### CLAIM OF PRIORITY

This application is based on and claims priority under 35 U.S.C. § 119 to Korean Patent Application No. 10-2023-0122954, filed on Sep. 15, 2023, in the Korean Intellectual Property Office, the disclosure of which is herein incorporated by reference in its entirety.

### BACKGROUND

### Field

The disclosure relates to deep learning-based visual intelligence model utilization, and more particularly, to a technology for acquiring visual explanation information for visually explaining a result derivation rationale of a visual intelligence model.

### Description of Related Art

A visual intelligence model, which is a deep learning-based artificial intelligence (AI) model receiving input of an image and performing various applications, is utilized for various purposes such as object detection, object tracking, image classification, image division, image transformation, image enhancement. Visual intelligence models vary in type and structure even if they are used for the same purpose.

However, such visual intelligence models may make it difficult for users to acquire visual explanation information for visually explaining result derivation rationales of visual intelligence models. In order to acquire visual explanation information, an interior structure of a corresponding visual intelligence model should be understood, and visual explanation information should be extracted therefrom. However, it is difficult to acquire visual explanation information since purposes of visual intelligence models and types and structures of models for achieving purposes are very diverse.

### SUMMARY

The disclosure has been developed in order to solve the above-described problems, and an object of the disclosure is to provide a method for acquiring visual explanation information from various visual intelligence models independently of the purposes, types, and structures of the visual intelligence models, that is, through one system, when there are visual intelligence models for various purposes and visual intelligence models of various types and structures are utilized for various purposes.

To achieve the above-described object, a visual explanation information acquisition system of a visual intelligence model according to an embodiment of the disclosure may include: a diversification module configured to generate N transformed images by diversifying an input image; a visual intelligence module configured to input the N transformed images to a deep learning-based visual intelligence model and to acquire outputted results; an attribute analysis module configured to generate attributes of the visual intelligence model from the results acquired by the visual intelligence module; an explanation basis derivation module configured to calculate losses of the visual intelligence model from the generated attributes, and to derive, from the calculated losses, basic data for generating a visual explanation map for visually explaining a result derivation rationale of the visual intelligence model; and an explanation visualization module configured to generate a visual explanation map from the derived basic data.

The diversification module may generate the N transformed images by applying N different kernels to the input image, and the N different kernels may be one of N Gaussian filter kernels which have different parameters, N color transfer kernels in which at least one of color elements is different, and N noise application kernels to which different Gaussian noise parameters are applied.

The visual intelligence model may include an image transformation or enhancement network, an image classification network, and an object detection network.

When the image transformation or enhancement network is applied as the visual intelligence model, the attribute analysis module may apply an analysis function to an area designated by a user in output images which are output results of the visual intelligence model, and may generate attributes of the visual intelligence model by summing or averaging results of applying, and the analysis function may be any one of a gradient function, a Laplacian function, and a formula type filtering function.

When the image classification network is applied as the visual intelligence model, the attribute analysis module may generate, as attributes, class probability values which are results outputted from the visual intelligence model.

When the object detection network is applied as the visual intelligence model, the attribute analysis module may randomly crop a part of a reference area designated by the user for the input image, and may extract a feature vector from the cropped area, may select an object detection area that belongs to the same class as the reference area designated by the user among object detection areas outputted from the visual intelligence model, and may crop the selected object detection area from the input image and may extract a feature map from the cropped area, and may generate attributes of the visual intelligence model by calculating similarity between the extracted feature maps.

The explanation basis derivation module may generate losses of the visual intelligence model by multiplying the generated attributes by a scale set by the user, and may generate gradient images for the input image by performing backwardation with respect to the generated losses.

The explanation basis derivation module may generate an average image by averaging N weight images which are generated by performing weight multiplication (element-wise multiplication) with respect to the N transformed images and the gradient images, and may derive an image resulting from normalization of the generate average image as basic data.

The explanation visualization module may generate a visual explanation map from the derived basic data through density estimation based on a probability distribution kernel.

According to another aspect of the disclosure, there is provided a visual explanation information acquisition method of a visual intelligence model, the visual explanation information acquisition method including: generating N transformed images by diversifying an input image; inputting the N transformed images to a deep learning-based visual intelligence model and acquiring outputted results; generating attributes of the visual intelligence model from the acquired results; calculating losses of the visual intelligence model from the generated attributes; deriving, from the calculated losses, basic data for generating a visual explanation map for visually explaining a result derivation rationale of the visual intelligence model; and generating a visual explanation map from the derived basic data.

According to still another aspect of the disclosure, there is provided a visual explanation information acquisition system of a visual intelligence model, the visual explanation information acquisition system including: a visual intelligence module configured to input N images to a deep learning-based visual intelligence model and to acquire outputted results; an attribute analysis module configured to generate attributes of the visual intelligence model from the results acquired by the visual intelligence module; an explanation basis derivation module configured to calculate losses of the visual intelligence model from the generated attributes, and to derive, from the calculated losses, basic data for generating a visual explanation map for visually explaining a result derivation rationale of the visual intelligence model; and an explanation visualization module configured to generate a visual explanation map from the derived basic data.

According to yet another aspect of the disclosure, there is provided a visual explanation information acquisition method of a visual intelligence model, the visual explanation information acquisition method including: inputting N images to a deep learning-based visual intelligence model and acquiring outputted results; generating attributes of the visual intelligence model from the acquired results; calculating losses of the visual intelligence model from the generated attributes, and deriving, from the calculated losses, basic data for generating a visual explanation map for visually explaining a result derivation rationale of the visual intelligence model; and generating a visual explanation map from the derived basic data.

As described above, according to embodiments of the disclosure, visual explanation information may be acquired and provided from various visual intelligence models independently of the purposes, types, and structures of the visual intelligence models, that is, through one system, when there are visual intelligence models for various purposes and visual intelligence models of various types and structures are utilized for various purposes.

According to embodiments of the disclosure, visual explanation information may be acquired through one system independently of the purpose, type, and structure of a visual intelligence model, and the visual explanation information may be usefully used for analyzing operations, performance, reliability of various intelligence models and changing a design and achieving advancement.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a structure of a visual explanation information acquisition system of a visual intelligence model according to an embodiment of the disclosure;

FIG. 2 is a view illustrating kernels for generating transformed images;

FIG. 3 is a view illustrating a detailed structure of an attribute analysis module; and

FIG. 4 is a view illustrating an attribute generation method of an object detection network.

### DETAILED DESCRIPTION

Hereinafter, the disclosure will be described in more detail with reference to the accompanying drawings.

Embodiments of the disclosure propose a visual explanation information acquisition system which is independent of the purpose, type, and structure of a visual intelligence model. The disclosure provides a technology for acquiring visual explanation information from various visual intelligence models through one system independently of the purpose, type, and structure of a visual intelligence model.

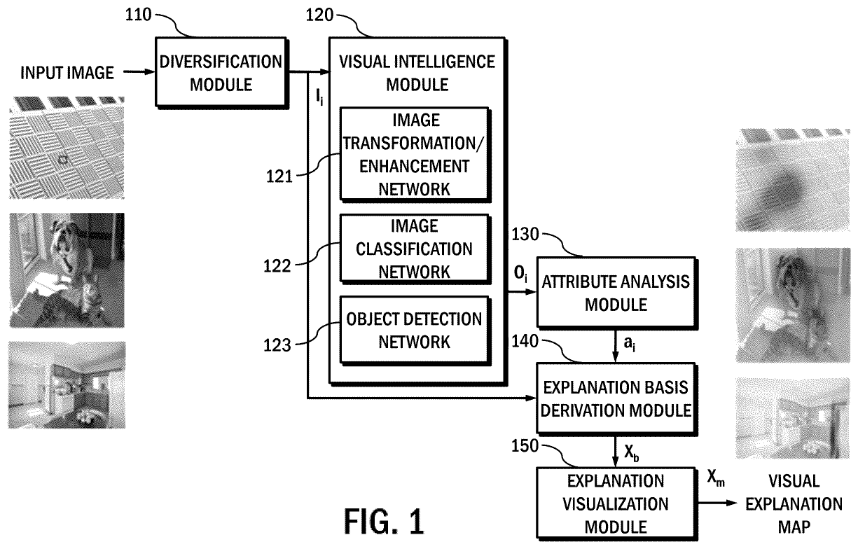

FIG. 1 is a view illustrating a structure of a visual explanation information acquisition system of a visual intelligence model according to an embodiment of the disclosure. The visual explanation information acquisition system according to an embodiment may include a diversification module 110, a visual intelligence module 120, an attribute analysis module 130, an explanation basis derivation module 140, and an explanation visualization module 150.

### 1. Diversification Module

The diversification module 110 generates a plurality of images by diversifying an input image. To achieve this, the diversification module 110 generates N transformed images (Iᵢ) by applying N different kernels (Kᵢ) to an input image (Iₒ) according to the following equation:

Iᵢ=Kᵢ(Iₒ), i=1˜N

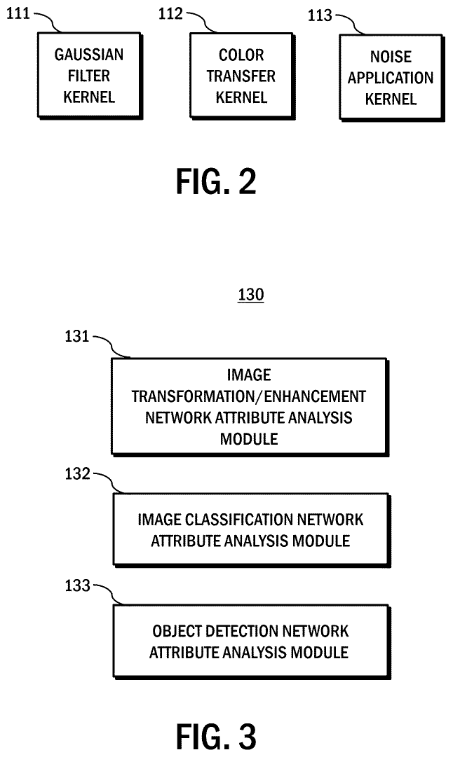

The N different kernels may be applied by selecting one of kernels shown in FIG. 2 as follows:
1) N Gaussian filter kernels 111 having different parameters;
2) N color transfer kernels 112 in which at least one of color elements (brightness, contrast, saturation, hue) is different; and
3) N noise application kernels 113 to which different Gaussian noise parameters are applied.

### 2. Visual Intelligence Module

The visual intelligence module 120 inputs the N transformed images generated by the diversification module 110 into a deep learning-based visual intelligence model, and acquires outputted results. The visual intelligence model loaded into the visual intelligence module 120 is a target model for acquiring visual explanation information for visually explaining a result derivation rationale.

There is no limitation to the purpose, type, and structure of the visual intelligence model. For the convenience of explanation, an image transformation or enhancement network 121, an image classification network 122, and an object detection network 123 will be mentioned as the visual intelligence model. Image transformation may include super resolution (SR) transformation, and image enhancement may include denoise, dehaze, etc. Output results (Oᵢ) of the visual intelligence model [M( )] may be expressed by the following equation:

Oᵢ=M(Iᵢ), i=1˜N

### 3. Attribute Analysis Module

The attribute analysis module 130 generates attribute information of the visual intelligence model 121, 122, 123, based on output results of the visual intelligence model which are acquired by the visual intelligence module 120. Attribute information generation methods by the attribute analysis module 130 vary according to visual intelligence models 121, 122, 123, and accordingly, the attribute analysis module 130 may include attribute analysis modules 131, 132, 133 corresponding to the respective visual intelligence models as shown in FIG. 3. Hereinafter, the respective attribute analysis modules will be described.

### 1) When the Visual Intelligence Model is the Image Transformation or Enhancement Network 121

Since the image transformation/enhancement network 121 receives input of an image and outputs a transformed or enhanced image, the input and output thereof are all images.

The image transformation/enhancement network attribute analysis module 131 generates attributes (aᵢ) of the visual intelligence model from output results (oᵢ) of the visual intelligence model and an analysis area (pos) designated by a user by using the following equation:

aᵢ=n(fᵣₑ(oᵢ,pos)), i=1˜N

The analysis area (pos) is a part of an image that the user intends to analyze, and may be designated as Bounding box (x1, y1, x2, y2). fᵣₑ (oᵢ, pos) is a function for selectively applying any analysis function of the Gradient function, the Laplacian function, and a formula type filtering function to the analysis area (pos) of output images (oᵢ) of the visual intelligence model. n( ) is a function for summing or averaging results of fᵣₑ (oᵢ, pos).

### 2) When the Visual Intelligence Model is the Image Classification Network 122

The image classification network 122 receives input of an image and outputs a class probability value. The image classification network attribute analysis module 132 may generate, as attributes (aᵢ) of the visual intelligence model, class probability values which are output results (oᵢ) of the visual intelligence model for the N transformed images by using the following equation:

aᵢ=oᵢ, i=1˜N

### 3) When the Visual Intelligence Model is the Object Detection Network 123

The object detection network 123 receives input of an image and outputs an object detection area, a class and reliability of a detected object. That is, the output of the object detection network 123 may be an object detection area, a class and reliability of a detected object.

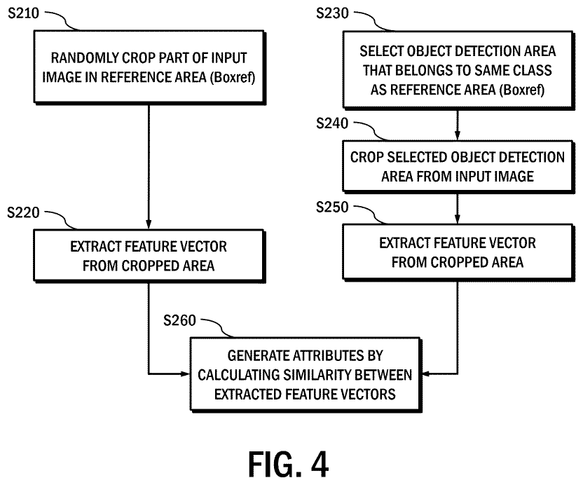

The object detection network attribute analysis module 133 generates attributes (aᵢ) of the visual intelligence model from i) outputs (oᵢ) of the visual intelligence model for the N transformed image, ii) a reference area designated by a user for an input image and a class of the reference area, and iii) an input image (Iₒ) according to a procedure illustrated in FIG. 4.

As shown in the drawing, the object detection network attribute analysis module 133 randomly crops a part of the input image within the reference area (Box_{ref}) designated by the user (S210), and extracts a feature vector from the cropped area (S220).

The object detection network attribute analysis module 133 selects an object detection area that belongs to the same class as the reference area designated by the user among object detection areas which are results outputted from the visual intelligence model (S230), crops the selected object detection area from the input image (S240), and extracts a feature vector from the cropped area (S250).

Thereafter, the object detection network attribute analysis module 133 generates attributes (aᵢ) by calculating similarity between the feature vector (feature_{ref}) extracted at step S220 and the feature vector (featureₒ) extracted at step S250 (S260) by using the following equation:

aᵢ=L(feature_{ref},featureₒ)

where L( ) is a function used for calculating similarity, such as a Similarity function, an L1-loss function.

### 4. Explanation Basis Derivation Module

The explanation basis derivation module 140 calculates losses (Lossᵢ) of the visual intelligence model based on the attributes (aᵢ) of the visual intelligence model generated by the attribute analysis module 130, by using the following equation:

$${Loss}_{i} = scale \times {a}_{i}$$

where scale is set to a value less than or equal to 1 by a user.

The explanation basis derivation module 140 generates gradient images [I_{grad}(i)] for the input image by performing backwardation with respect to the calculated losses (Lossᵢ) by using the following equation:

I_{grad}(i)=Backward_{M}(Lossᵢ)

where Backward_{M}( ) is a backwardation function of the visual intelligence model.

The gradient images [I_{grad}(i)] generated by the explanation basis derivation module 140 are used as basic data for generating a visual explanation map which is visual explanation information for visually explaining a result derivation rationale of the visual intelligence model.

Thereafter, the explanation basis derivation module 40 generates an average image (Xₛ) by averaging N weight images [X(i)] which are generated by performing weight multiplication (element-wise multiplication (⊗)) with respect to the N transformed images (Iᵢ) and the gradient images [I_{grad}(i)], and derives an image (X_{b}) resulting from normalization of the average image (Xₛ) as a rationale explanation basis of the visual intelligence model, by using the following equations:

$$X ( i ) = {I}_{i} ⊗ {I}_{grad} ( i ) , i = 1 ∼ N$$

$${X}_{s} = \frac{1}{N} {\sum }_{i = 1}^{N} X ( i ) ,$$

$${X}_{b} = \frac{{X}_{s} - min ( {X}_{s} )}{max ( {X}_{s} ) - min ( {X}_{s} )}$$

### 5. Explanation Visualization Module

The explanation visualization module 150 generates a visual explanation map from the rationale explanation basis of the visual intelligence model which is derived by the explanation basis derivation module 140. Specifically, the explanation visualization module 150 generates a visual explanation map (Xₘ) from the rationale explanation basis (X_{b}) of the visual intelligence model through density estimation based on a probability distribution kernel by using the following equation:

Xₘ=f_{kde}(X_{b})

where f_{kde} is a function for kernel density estimation.

### 6. Variations

Up to now, a system and a method for acquiring visual explanation information independent of the purpose, type, and structure of a visual intelligence model have been described in detail with reference to preferred embodiments.

Embodiments of the disclosure propose a method for acquiring visual explanation information from various visual intelligence models through one system when there are visual intelligence models for various purposes and visual intelligence models of various types and structures are utilized for various purposes. The method and system according to embodiments may be usefully used for analyzing operations, performance, reliability of various intelligence models and changing a design and achieving advancement.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A visual explanation information acquisition system of a visual intelligence model, the visual explanation information acquisition system comprising:
a diversification module configured to generate N transformed images by diversifying an input image;
a visual intelligence module configured to input the N transformed images to a deep learning-based visual intelligence model and to acquire outputted results;
an attribute analysis module configured to generate attributes of the visual intelligence model from the results acquired by the visual intelligence module;
an explanation basis derivation module configured to calculate losses of the visual intelligence model from the generated attributes, and to derive, from the calculated losses, basic data for generating a visual explanation map for visually explaining a result derivation rationale of the visual intelligence model; and
an explanation visualization module configured to generate a visual explanation map from the derived basic data.

2. The visual explanation information acquisition system of claim 1, wherein the diversification module is configured to generate the N transformed images by applying N different kernels to the input image,
wherein the N different kernels are one of N Gaussian filter kernels which have different parameters, N color transfer kernels in which at least one of color elements is different, and N noise application kernels to which different Gaussian noise parameters are applied.

3. The visual explanation information acquisition system of claim 1, wherein the visual intelligence model comprises an image transformation or enhancement network, an image classification network, and an object detection network.

4. The visual explanation information acquisition system of claim 3, wherein the attribute analysis module is configured to, when the image transformation or enhancement network is applied as the visual intelligence model, apply an analysis function to an area designated by a user in output images which are output results of the visual intelligence model, and to generate attributes of the visual intelligence model by summing or averaging results of applying, and
wherein the analysis function is any one of a gradient function, a Laplacian function, and a formula type filtering function.

5. The visual explanation information acquisition system of claim 3, wherein the attribute analysis module is configured to, when the image classification network is applied as the visual intelligence model, generate, as attributes, class probability values which are results outputted from the visual intelligence model.

6. The visual explanation information acquisition system of claim 3, wherein the attribute analysis module is configured to: when the object detection network is applied as the visual intelligence model,
randomly crop a part of a reference area designated by the user for the input image, and extract a feature vector from the cropped area;
select an object detection area that belongs to the same class as the reference area designated by the user among object detection areas outputted from the visual intelligence model, and crop the selected object detection area from the input image and extract a feature map from the cropped area; and
generate attributes of the visual intelligence model by calculating similarity between the extracted feature maps.

7. The visual explanation information acquisition system of claim 1, wherein the explanation basis derivation module is configured to generate losses of the visual intelligence model by multiplying the generated attributes by a scale set by the user, and to generate gradient images for the input image by performing backwardation with respect to the generated losses.

8. The visual explanation information acquisition system of claim 7, wherein the explanation basis derivation module is configured to generate an average image by averaging N weight images which are generated by performing weight multiplication (element-wise multiplication) with respect to the N transformed images and the gradient images, and to derive an image resulting from normalization of the generate average image as basic data.

9. The visual explanation information acquisition system of claim 8, wherein the explanation visualization module is configured to generate a visual explanation map from the derived basic data through density estimation based on a probability distribution kernel.

10. A visual explanation information acquisition method of a visual intelligence model, the visual explanation information acquisition method comprising:
generating N transformed images by diversifying an input image;
inputting the N transformed images to a deep learning-based visual intelligence model and acquiring outputted results;
generating attributes of the visual intelligence model from the acquired results;
calculating losses of the visual intelligence model from the generated attributes;
deriving, from the calculated losses, basic data for generating a visual explanation map for visually explaining a result derivation rationale of the visual intelligence model; and
generating a visual explanation map from the derived basic data.

11. A visual explanation information acquisition system of a visual intelligence model, the visual explanation information acquisition system comprising:
a visual intelligence module configured to input N images to a deep learning-based visual intelligence model and to acquire outputted results;
an attribute analysis module configured to generate attributes of the visual intelligence model from the results acquired by the visual intelligence module;
an explanation basis derivation module configured to calculate losses of the visual intelligence model from the generated attributes, and to derive, from the calculated losses, basic data for generating a visual explanation map for visually explaining a result derivation rationale of the visual intelligence model; and
an explanation visualization module configured to generate a visual explanation map from the derived basic data.
